(19) United States
(12) Patent Application Publication
(10) Pub. No.: US 2014/0167315 A1
(43) Pub. Date: Jun. 19, 2014

(54) Continuous Fiber Reinforced Biocomposites and Polymers

(71) Applicants: David E. Walrath, Laramie, WY (US); Heath Van Eaton, Torrington, WY (US)

(72) Inventors: David E. Walrath, Laramie, WY (US); Heath Van Eaton, Torrington, WY (US)

(21) Appl. No.: 13/886,288

(22) Filed: May 3, 2013

Related U.S. Application Data
(60) Provisional application No. 61/642,703, filed on May 4, 2012.

(51) Int. Cl. B29C 47/12

(52) U.S. Cl. CPC B29C 47/12
USPC 264/176.1; 425/465

(57) ABSTRACT

A device for introducing continuous fiber into a product material is provided. The continuous fiber is provided from at least one continuous fiber supply. The device comprises a housing having a first opening and a second opening. A channel is formed through the housing from the first opening to the second opening. At least one fin member extends from the housing into the channel with the at least one fin member having a conduit formed therethrough. Upon the product material travelling through the channel of the housing, the continuous fiber travels from the continuous fiber supply, through the conduit, and into the product material. The continuous fiber increases strength and stiffness of the product material while decreasing time-dependent creep deformation of the product material.

The present application claims benefit of priority of pending provisional patent application Ser. No. 61/642,703, filed on May 4, 2013, entitled “Continuous Fiber Reinforced Biocomposites and Polymers”.

### BACKGROUND OF THE INVENTION

1. Field of the Invention

This invention relates generally to continuous fiber reinforced biocomposites and polymers and, more particularly, the invention relates to introducing continuous (organic or inorganic) fiber(s) into random natural fiber reinforced polymer composites or all polymer-based profiles that are used in building material, construction, and/or outdoor living applications such as decking, framing systems for decking, fencing and other applications thereby increasing strength and stiffness while decreasing creep.

2. Description of the Prior Art

Historically the composite lumber industry has been limited to non-structural applications such as decking, molding/trim, landscaping, fencing and windows/doors. The physical properties of all plastic, vinyl and composite lumber products made from HDPE, LDPE, Polypropylene, Biopolymers or other polymers reinforced with natural fibers like wood, wheat straw, rice hauls, kenaf and others experience creep and rupture at lower ultimate load levels and in shorter time periods compared to other materials like wood used in similar types of applications and structural applications.

Wood plastic composites and all plastic lumber technologies first began introduction into market in the late 1980's and early 1990's and the respective technologies were in their infancy. The original wood plastic composites and all plastic lumber technologies were plagued with performance issues like premature fade and bleaching, mold and mildew, sagging, excessive expansion/contraction and they all lacked strength and stiffness required to serve in structural applications. In an effort to add strength and stiffness to synthetic lumber companies have attempted to add fiberglass and other types of fibers utilizing various processes. These efforts have not been completely successful.

### SUMMARY

The present invention is a device for introducing continuous fiber into a product material is provided. The continuous fiber is provided from at least one continuous fiber supply. The device comprises a housing having a first opening and a second opening. A channel is formed through the housing from the first opening to the second opening. At least one fin member extends from the housing into the channel with the at least one fin member having a conduit formed therethrough. Upon the product material travelling through the channel of the housing, the continuous fiber travels from the continuous fiber supply, through the conduit, and into the product material. The continuous fiber increases strength and stiffness of the product material while decreasing time-dependent creep deformation of the product material.

In addition, the present invention includes a method for introducing continuous fiber into a product material with the continuous fiber being provided from at least one continuous fiber supply. The method comprises providing an extrusion die tool housing having a first opening and a second opening with the first opening being larger than the second opening, forming a channel through the housing from the first opening to the second opening, forming the product material as the product material travels through the channel, softening the product material as the product material travels through the channel, extending a plurality of fin members from the housing into the channel, forming a conduit through each fin member, supplying the continuous fiber from the continuous fiber supply, through the conduit, and into the product material, and increasing strength and stiffness of the product material while decreasing time-dependent creep deformation of the product material.

The present invention further includes a device for introducing continuous fiber into a product material. The continuous fiber is provided from at least one continuous fiber supply. The device comprises an extrusion die tool housing having a first opening and a second opening with the first opening being larger than the second opening. A channel is formed through the housing from the first opening to the second opening with the product material being formed as the product material travels through the channel. A heating element is mounted within the housing for softening the product material as the product material travels through the channel. A plurality of fin members extend from the housing into the channel with each fin member having a conduit formed therethrough. Upon the product material travelling through the channel of the housing, the continuous fiber travels from the continuous fiber supply, through the conduit, and into the product material. The continuous fiber increases strength and stiffness of the product material while decreasing time-dependent creep deformation of the product material.

### BRIEF DESCRIPTION OF THE DRAWINGS

FIG. 1 is a rear perspective view illustrating an extrusion die tool having a continuous fiber feeding zone, constructed in accordance with the present invention;

FIG. 2 is another rear perspective view illustrating the extrusion die tool having the continuous fiber feeding zone, constructed in accordance with the present invention, with feeding fins for introducing the continuous fiber into the product;

FIG. 3 is still another rear perspective view illustrating the extrusion die tool having the continuous fiber feeding zone, constructed in accordance with the present invention, with the feeding fins for introducing the continuous fiber into the product;

FIG. 4 is yet another rear perspective view illustrating the extrusion die tool having the continuous fiber feeding zone, constructed in accordance with the present invention, with the feeding fins for introducing the continuous fiber into the product;

FIG. 5 is a front perspective view illustrating the extrusion die tool having the continuous fiber feeding zone, constructed in accordance with the present invention, with feeding fins for introducing the continuous fiber into the product;

FIG. 6 is another front perspective view illustrating the extrusion die tool having the continuous fiber feeding zone, constructed in accordance with the present invention, with feeding fins for introducing the continuous fiber into the product;

FIG. 7 is a rear elevational view illustrating the feeding fin, constructed in accordance with the present invention;

FIG. 8 is a side elevational view illustrating the feeding fin, constructed in accordance with the present invention;

FIG. 9 is a front elevational view illustrating the feeding fin, constructed in accordance with the present invention;

FIG. 10 is an side view illustrating the feeding fins feeding and locating the continuous fibers into the extrusion die tool, constructed in accordance with the present invention;

FIG. 11 is a front view illustrating the feeding fins feeding and locating the continuous fibers into the extrusion die tool, constructed in accordance with the present invention; and

FIG. 12 is a perspective view illustrating the feeding fins feeding and locating the continuous fibers into the extrusion die tool, constructed in accordance with the present invention.

### DETAILED DESCRIPTION OF THE PREFERRED EMBODIMENTS

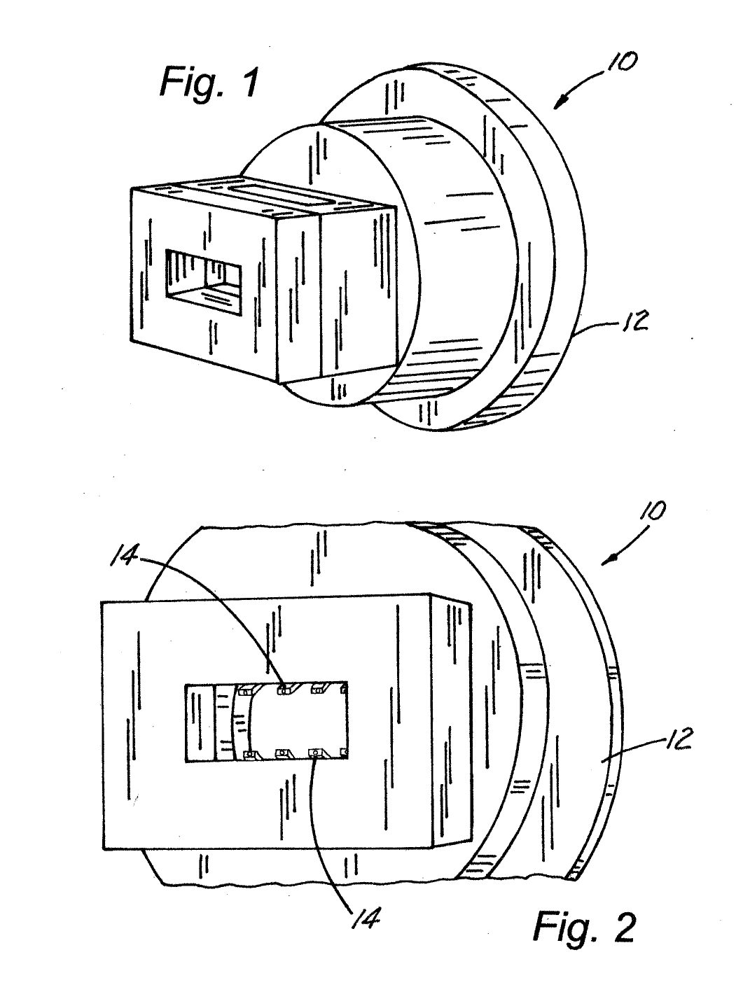

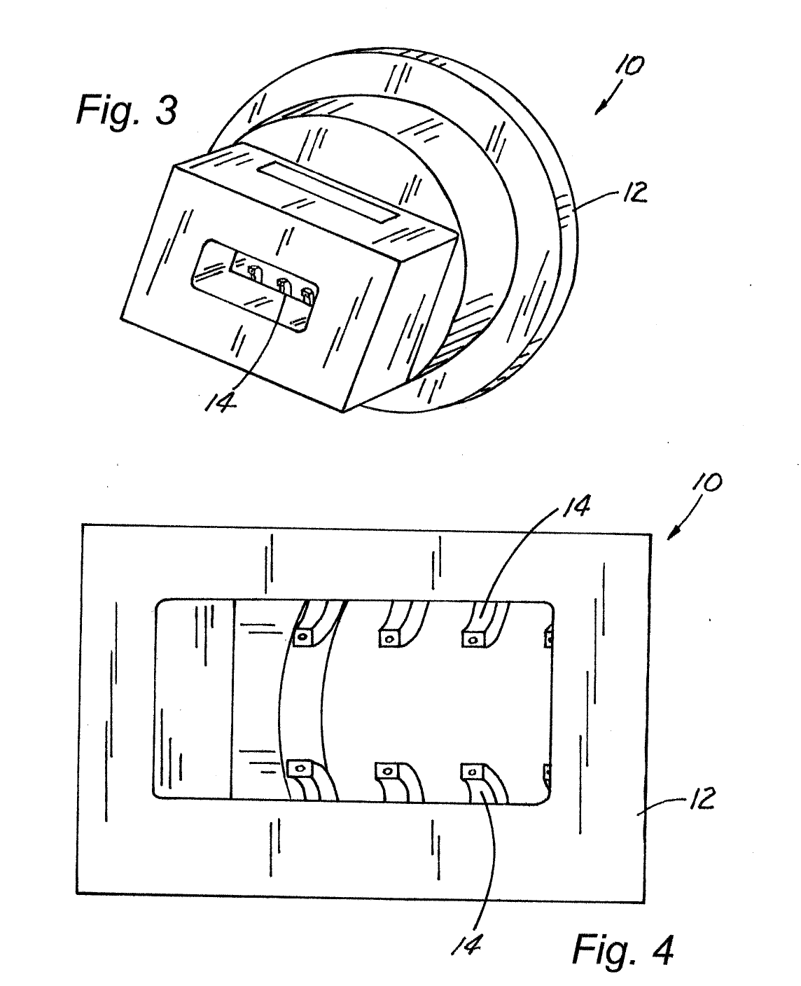

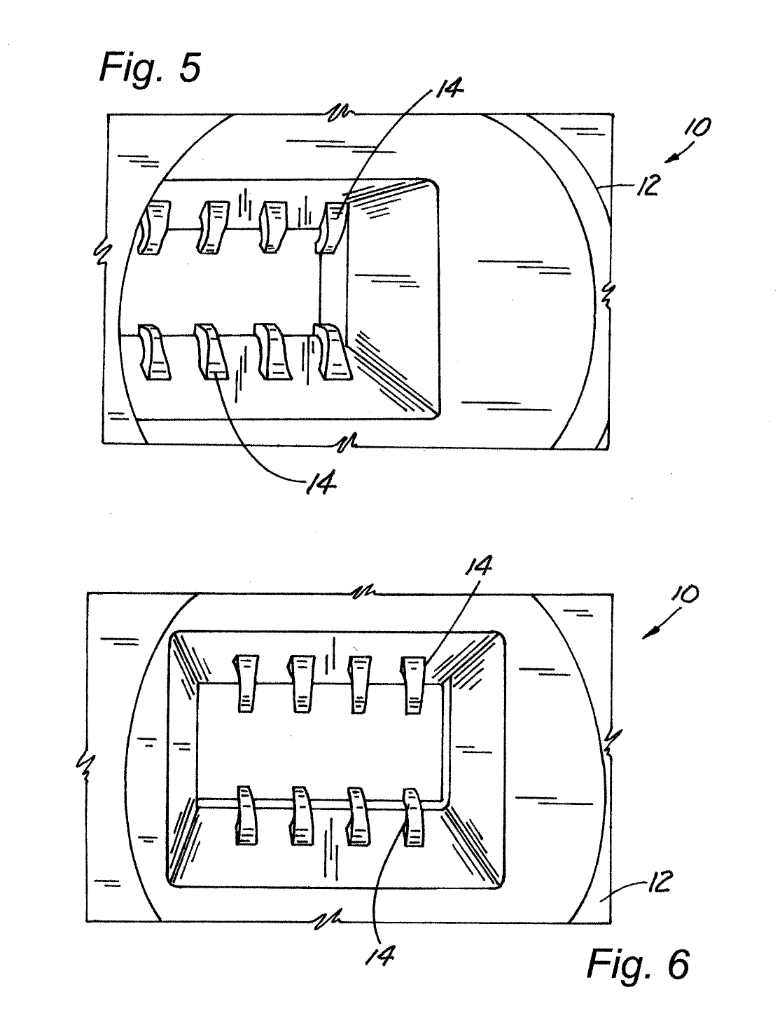

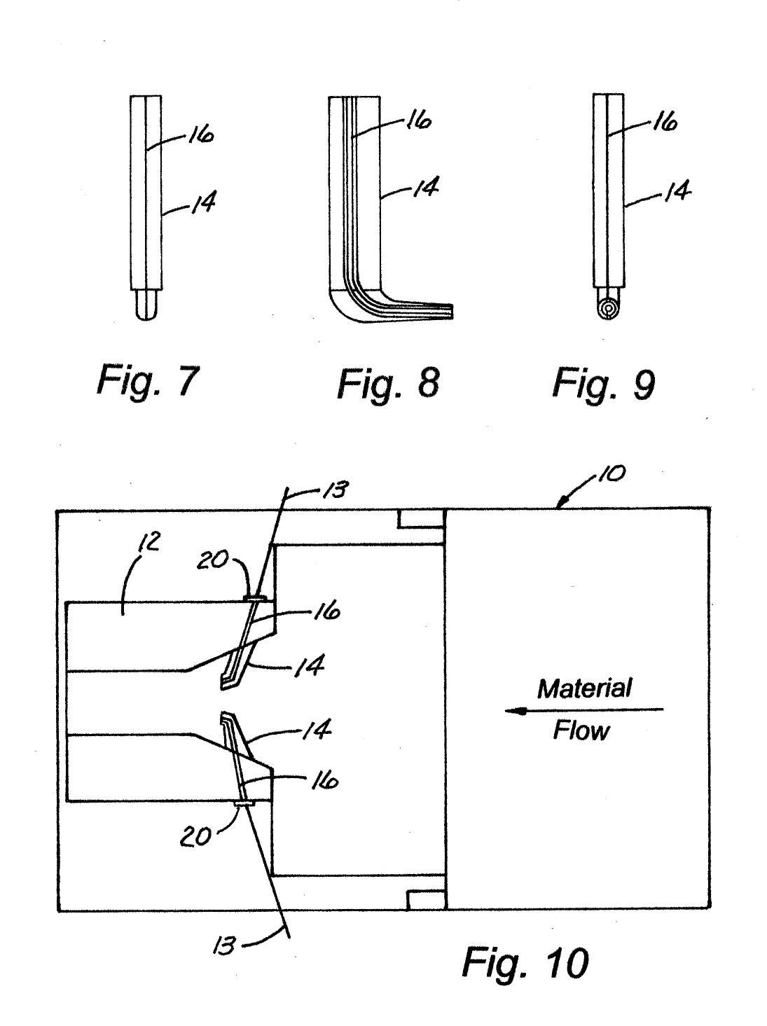

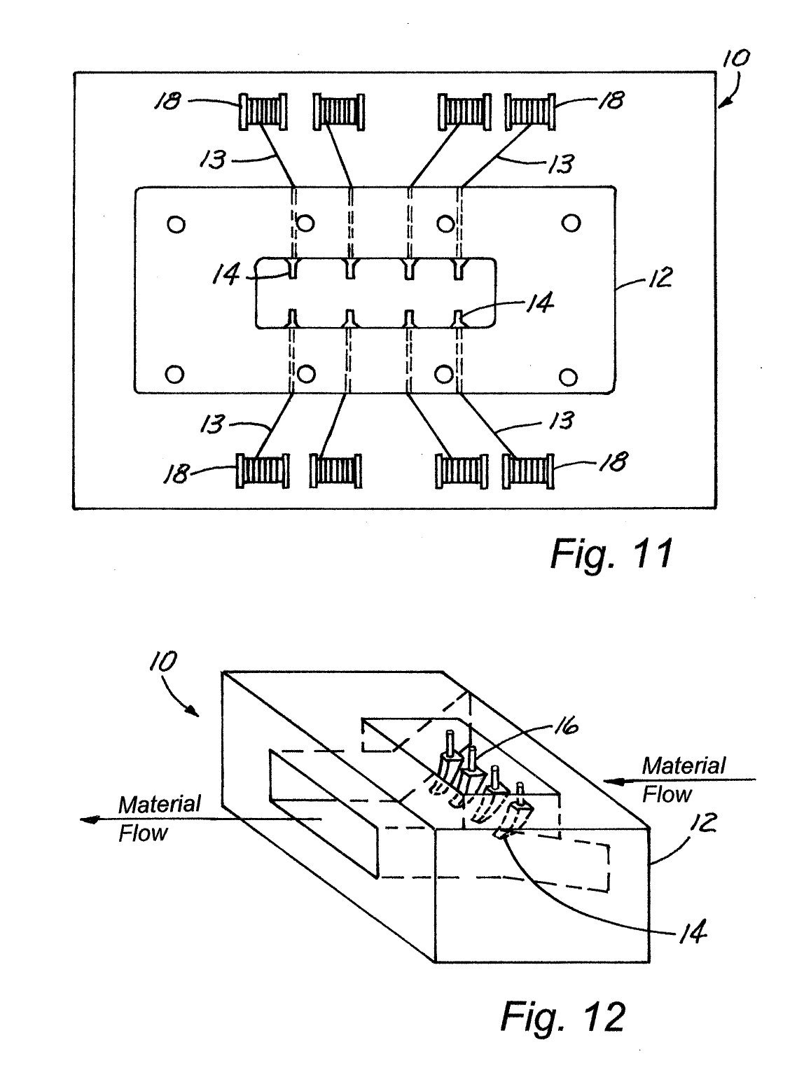

As illustrated in FIGS. 1-12, the present invention is a device, indicated generally at 10, and a process of introducing continuous (organic or inorganic) fiber(s) 13 into random natural fiber reinforced polymer composites or all polymer-based profiles that are used in building material, construction, and/or outdoor living applications such as decking, framing systems for decking, fencing and other applications thereby increasing strength and stiffness while decreasing creep. Continuous reinforcing fibers 13 (organic or inorganic) are introduced into the product in the final forming extrusion die tool 12 using feeding fins 14 such that the continuous fibers 13 are placed below the surface of the finished shape and performs a function of increasing strength and stiffness while decreasing time-dependent creep deformation. The device 10 of the present invention can be retro-fitted into the existing production processes employed by companies currently in the market that produce natural fiber reinforced polymer composites and/or all polymer products.

The present invention creates device 10 and a die/tooling process that embeds one or more continuous fibers 13 (organic or inorganic) in the final forming die section using its heat and pressure in combination with optional fiber coatings to enhance the bond between continuous fibers 13 and the product's polymer matrix core. This differs from pultrusion technologies where the fibers are resin impregnated as a stage prior to entering the final forming die. The continuous fibers 13 (organic or inorganic) can be integrated into solid profile extrusions or the walls/cavities of hollow profile extrusions.

The continuous fibers 13 (organic or inorganic) are integrated into the body of the extrusion by means of the protruded “fins” 14 in the final forming die 12 that are sized such that placement of the fiber/s 13 are controlled and specifically embedded at locations designed to maximize the strength and stiffness of the product/s, whether composite lumber or all plastic lumber profiles. The feeding “fins” 14 contain a hollow zone 16 used to insert the continuous fibers 13 into the forming die in addition to controlling placement of continuous fiber's 13 depth within the product profile. The feeding “fins” 14 are adjustable (in and out) via a channel in the final forming die so that the “fins” 14 can be loosened and the depths properly adjusted to meet specified fiber depths. The fins 14 are sized such that to minimize material flow restriction and to prevent compression/decompression issues.

The fins 14 can have a sharpened edge that aids in material flow. In a preferred production set up, a specified number of fiber spools 18 of continuous fiber 13 are braced near the die/tooling section 12 so that the distance of the fiber spool/s 13 to the die 12 are minimized. The rotation speed of fiber spools 18 can be controlled via independent motors or by the extrusion speed of the natural fiber polymer composite or all polymer extrusion passing through the final extrusion forming die 12. If controlled by motors, it is recommended the motor speeds are adapted via the controller and speed controls of the downstream puller.

The types, shapes, sizes and number of organic or inorganic continuous fibers 13 specified to a particular product depends upon the final product's target costing, application and physical property requirements. Natural fiber polymer composites, inorganic fiber polymer composites and all plastic lumber profiles have varying levels of physical properties and each require their own unique set of design values including, but not limited to, the location of fiber/s, the types of fibers, sizes, coatings if needed and so on.

The “feeding fin” inlets and outlets have or can have ceramic “eyes” 20 that are used to minimize wear from the continuous fibers 13 travel through the respective feeding channels 16. The inlet and outlet holes are points that are most subject to potential wear from the abrasive properties of organic or inorganic continuous fibers 13.

The “feeding fin” sections (top and bottom or all sides) of the final forming die 12 can be designed as an insert section within the final forming die itself. Purposes of this include, but are not limited to:
1) Ability to change out a section of feeding fins 14 rather than replacement of an it entire die 12;
2) Cost savings;
3) Ability to replace sections that are wearing while leaving other sections that are wearing at lower rates;
4) Repair of feeding fin sections 14 within the die 12 that may be damaged during setup, tear down or during production while having the ability to leave sections that are not damaged; and
5) Ability of change out feeding fin sections 14 that are made of steels/metals with varying levels hardness or coatings;

The dies 12 can made from a number of different types of stainless steel and metals depending on the nature of the polymer extrusion and its ingredients to avoid premature degradation and wear of the metal/s and/or coatings, the level of material viscosity, level of abrasive materials within the composition of the polymer matrix, heat and pressure requirements, size and types of extrusion profiles being made, throughput rate of extruder and/or other components, and budget and costing variables.

It is important in most extrusion processes to maintain and balance the levels of die pressure with the heat of the extrusion. Notably, higher die pressures create additional heat, but pressure is needed to a certain degree in order to fill all the cavities, corners and orifices of the open die sections so that the final part being extruded meets/exceeds the specified dimensional shape tolerances and requirements.

The inclusion of feeding “fins” 14 used to feed continuous fibers 12 into the final forming die 12 displaces area within the extrusion die open area and importance must be given to designing the final die section to account for the fin's area displacement, otherwise a section of decompression will be created after the fiber 13 is fed and the bonding will be compromised with the resulting lack of needed pressure. Proper taper and surface area reduction must be estimated when designing the die/tooling section for each respective, individual product taking into consideration the composition of the natural fiber polymer composite and all plastic products formulations.

The foregoing exemplary descriptions and the illustrative preferred embodiments of the present invention have been explained in the drawings and described in detail, with varying modifications and alternative embodiments being taught. While the invention has been so shown, described and illustrated, it should be understood by those skilled in the art that equivalent changes in form and detail may be made therein without departing from the true spirit and scope of the invention, and that the scope of the present invention is to be limited only to the claims except as precluded by the prior art. Moreover, the invention as disclosed herein may be suitably practiced in the absence of the specific elements which are disclosed herein.

What is claimed is:

1. A device for introducing continuous fiber into a product material, the continuous fiber being provided from at least one continuous fiber supply, the device comprising:
a housing having a first opening and a second opening;
a channel formed through the housing from the first opening to the second opening; and
at least one fin member extending from the housing into the channel, the at least one fin member having a conduit formed therethrough;
wherein upon the product material travelling through the channel of the housing, the continuous fiber travels from the continuous fiber supply, through the conduit, and into the product material; and
wherein the continuous fiber increases strength and stiffness of the product material while decreasing time-dependent creep deformation of the product material.

2. The device of claim 1 wherein the continuous fiber is selected from the group consisting of organic and or inorganic fiber.

3. The device of claim I wherein the housing is an extrusion die tool, and further comprising:
a heating element within the housing for softening the product material as the product material travels through the channel.

4. The device of claim 3 wherein the first opening is larger than the second opening, the product material being formed as the product material exits the second opening.

5. The device of claim 4 wherein the product material is selected from the group consisting of random natural fiber reinforced polymer composites and all polymer-based profiles used in building material, construction, and outdoor living applications.

6. The device of claim 1 wherein the continuous fibers are placed below an outer surface of the product material.

7. The device of claim 1 and further comprising:
a plurality of fin members extending from the housing into the channel, each fin member having a conduit formed therethrough;
wherein each fin member is associated with a different continuous fiber supply.

8. The device of claim 7 and further comprising:
a coating on each of the fibers for enhancing bond between continuous fibers and the polymer matrix core of the product material.

9. The device of claim 1 wherein the product material is hollow, the continuous fiber integrated into walls/cavities of the hollow area.

10. The device of claim 1 wherein the at least one fin member is depth adjustable into and out of the channel relative to the housing.

11. The device of claim 1 wherein the at least one fin member has a sharpened edge.

12. The device of claim 1 wherein inlets and outlets on the at least one fin member has a ceramic eye.

13. A device for introducing continuous fiber into a product material, the continuous fiber being provided from at least one continuous fiber supply, the device comprising:
an extrusion die tool housing having a first opening and a second opening, the first opening being larger than the second opening;
a channel formed through the housing from the first opening to the second opening, the product material being formed as the product material travels through the channel;
a heating element within the housing for softening the product material as the product material travels through the channel;
a plurality of fin members extending from the housing into the channel, each fin member having a conduit formed therethrough;
wherein upon the product material travelling through the channel of the housing, I 1 the continuous fiber travels from the continuous fiber supply, through the conduit, and into the product material; and
wherein the combination continuous fiber increases strength and stiffness of the product material while decreasing time-dependent creep deformation of the product material.

14. The device of claim 13 wherein the continuous fibers are placed below an outer surface of the product material.

15. The device of claim 13 wherein each fin member is associated with a different continuous fiber supply.

16. The device of claim 13 and further comprising:
a coating on each of the fibers for enhancing bond between continuous fibers and the polymer matrix core of the product material.

17. The device of claim 13 wherein the product material is hollow, the continuous fiber integrated into walls/cavities of the hollow area.

18. The device of claim 13 wherein each one fin member is independently depth adjustable into and out of the channel relative to the housing.

19. The device of claim 13 wherein inlets and outlets on the at least one fin member has a ceramic eye.

20. A method for introducing continuous fiber into a product material, the continuous fiber being provided from at least one continuous fiber supply, the method comprising:
providing an extrusion die tool housing having a first opening and a second opening, the first opening being larger than the second opening;
forming a channel through the housing from the first opening to the second opening;
forming the product material as the product material travels through the channel;
softening the product material as the product material travels through the channel;
extending a plurality of fin members from the housing into the channel;
forming a conduit through each fin member;
supplying the continuous fiber from the continuous fiber supply, through the conduit, and into the product material; and
increasing strength and stiffness of the product material while decreasing time-dependent creep deformation of the product material.
